(19) United States
(12) Patent Application Publication
(10) Pub. No.: US 2022/0189751 A1
(43) Pub. Date: Jun. 16, 2022

(54) IMAGING MASS SPECTROMETER

(71) Applicant: SHIMADZU CORPORATION, Kyoto-shi, Kyoto (JP)

(72) Inventor: Shinichi YAMAGUCHI, Kyoto-shi, Kyoto (JP)

(73) Assignee: SHIMADZU CORPORATION, Kyoto-shi, Kyoto (JP)

(21) Appl. No.: 17/439,846

(22) PCT Filed: Apr. 24, 2019
(86) PCT No.: PCT/JP2019/017368

§ 371 Date: Sep. 16, 2021

(51) Int. Cl. H01J 49/00; H01J 49/16

(52) U.S. Cl. CPC H01J 49/0004; H01J 49/164

(57) ABSTRACT

An imaging mass spectrometer includes an analysis executing section that executes MSⁿ analysis (n≥2) for a target component on each of a plurality of micro regions set in a two-dimensional or three-dimensional measurement region on a sample to collect data; a product ion extracting section that extracts product ions observed in the sample based on at least a part of the data collected by the analysis executing section; a two-dimensional distribution image creating section that creates a two-dimensional distribution image based on data of precursor ions and two-dimensional distribution images based on data of the product ions at the time of the MSⁿ analysis; and a distribution relationship visualization section that examines a relationship of the two-dimensional distribution images of the precursor ions and the product ions, creates a figure or graph indicating an inclusion relationship of the two-dimensional distribution images, and displays the figure or graph.

### TECHNICAL FIELD

The present invention relates to an imaging mass spectrometer configured to execute mass spectrometry for each of a large number of measurement points (micro regions) within a two-dimensional region on a sample or within a three-dimensional region in a sample.

### BACKGROUND ART

In the imaging mass spectrometer, a two-dimensional intensity distribution of ions having a specific mass-to-charge ratio m/z on the surface of a sample such as a biological tissue section can be measured while observing the form of the surface of the sample with an optical microscope (see Patent Literature 1 etc.). In the imaging mass spectrometer, a mass spectrometry image (hereinafter, sometimes referred to as an MS image), which shows a two-dimensional intensity distribution of ions at various mass-to-charge ratios, can be created for one sample.

In a general imaging mass spectrometer, a matrix-assisted laser desorption/ionization (MALDI) method is used as an ionization method, and components in a sample are directly ionized by irradiation of laser light. Therefore, not only the component targeted by the user but also many other components existing at the same position or in its vicinity on the sample are ionized at the same time and subjected to mass spectrometry. Components having sufficiently different mass-to-charge ratios can be separated from each other in mass spectrometry, but particularly in the case of a sample derived from a living body, many of the different components have the same or close masses, and are often not sufficiently separated in mass spectrometry. Therefore, even if an MS image is created using a signal strength at a certain mass-to-charge ratio (m/z) value, there is a case where an MS image of another mass-to-charge ratio value within an allowable range of the mass-to-charge ratio value or an MS image of another component having the same mass-to-charge ratio is overlapped, and there is a problem that it is difficult to accurately grasp the two-dimensional distribution of the target component.

As a method for solving this problem, a method is known in which MS/MS analysis (or MSⁿ analysis in which n is greater than or equal to 3) of a target component is executed, and an MS image is created using signal strength of product ions expected to be generated from the target component.

### CITATION LIST

### Patent Literature

Patent Literature 1: WO 2018/037491 A

### Non Patent Literature

Non Patent Literature 1: “Image segmentation”, [online], Mathworks Inc., [Search on Apr. 9, 2019], Internet <URL: https://jp.mathworks.com/help/images/image-segmentation.html>

Non Patent Literature 2: “Color-based segmentation using k-means clustering”, [online], Mass Works (Mathworks), [searched on Apr. 9, 2019], Internet <URL: https://jp.mathworks.com/help/images/color-based-segmentation-using-k-means-clustering.html>

### SUMMARY OF INVENTION

### Technical Problem

In an ion dissociation operation in the MS/MS analysis (or MSⁿ analysis), usually, a plurality of product ions having mass-to-charge ratios different from each other are generated from one precursor ion derived from one component. Therefore peaks of the plurality of product ions derived from the one component are observed in the product ion spectrum. Furthermore, since a precursor ion derived from another component may have the same mass-to-charge ratio, a peak of product ions derived from the other component different from the one component is also observed in the product ion spectrum. In addition, if a precursor ion is selected in an ion trap or the like, an ion or ions whose mass-to-charge ratio fall within a mass-to-charge ratio range having a certain width are also selected. Thus, if another component whose mass-to-charge ratio is close to the mass-to-charge ratio of the target component exists, a peak or peaks of product ions derived from such another component are also observed in the product ion spectrum.

As described above, peaks derived from a plurality of product ions derived from a target component and a plurality of product ions derived from components other than the target component are observed in the product ion spectrum. Conventionally, only a specific product ion assumed to be derived from a target component is selected among the product ions, and only an MS image showing its distribution is created. Although the specific product ion selected at that time are not necessarily the ion truly derived from the target component, information that allows the user to verify such a fact are not provided in the conventional device. In addition, in the conventional device, information on whether another component having a mass-to-charge ratio same as or close to that of the target component exists in the sample is also not provided to the user.

The present invention has been made to solve the above problems, and a main object is to provide an imaging mass spectrometer capable of providing a user with useful information regarding a two-dimensional distribution of a target component and other component contained in a sample by effectively using information obtained by performing MSⁿ analysis in which n is greater than or equal to 2, thereby enabling the user to obtain an MS image which is more suited to, for example, the user's intention and purpose.

### Solution to Problem

One aspect of an imaging mass spectrometer according to the present invention includes:

an analysis executing section configured to execute MSⁿ analysis (n is an integer greater than or equal to 2) for a target component on each of a plurality of micro regions set in a two-dimensional measurement region on a sample or a three-dimensional measurement region in a sample to collect data;

a product ion extracting section configured to extract a plurality of product ions observed in the sample based on at least a part of the data collected by the analysis executing section;

a two-dimensional distribution image creating section configured to create a two-dimensional distribution image based on data of precursor ions and two-dimensional distribution images based on data of the plurality of product ions at the time of the MSⁿ analysis; and

a distribution relationship visualization section configured to examine a relationship of the two-dimensional distribution images of the precursor ions and the plurality of product ions, create a figure or a graph indicating an inclusion relationship of the two-dimensional distribution images, and display the figure or the graph on a display unit.

Note that the difference in mass-to-charge ratio between the precursor ion and the product ion corresponds to a neutral loss, and if the precursor ion is determined, the product ion and the neutral loss correspond one-to-one. Therefore, in the imaging mass spectrometer according to the present invention, it is assumed that the product ion also includes neutral loss.

### Advantageous Effects of Invention

According to the above aspect of the imaging mass spectrometer of the present invention, a user can easily visually grasp a relationship of a plurality of product ions observed on a product ion spectrum obtained by the MSⁿ analysis for a target component, for example, whether the product ions are product ions derived from the same component or product ions derived from another component, by looking at the figure or the graph displayed on the display unit by the distribution relationship visualization section. Thus, for example, the user can select an appropriate product ion from a plurality of product ions derived from the target component, create an MS image, and confirm its distribution. Otherwise the user can select a product ion of a component other than the target component, create an MS image, and confirm its distribution. As a result, the user can obtain useful information regarding the two-dimensional distribution of the target component contained in the sample and the component other than the target component, that is, the user can obtain new knowledge which cannot be obtained by the conventional device.

### BRIEF DESCRIPTION OF DRAWINGS

FIG. 1 is a configuration diagram of a main part of an imaging mass spectrometer according to one embodiment of the present invention.

FIGS. 2A to 2E are explanatory diagrams of a characteristic analysis processing in the imaging mass spectrometer of the present embodiment.

FIG. 3 is a diagram showing another output example of the analysis processing result in the imaging mass spectrometer of the present embodiment.

### DESCRIPTION OF EMBODIMENTS

Hereinafter, one embodiment of an imaging mass spectrometer according to the present invention will be described with reference to the accompanying drawings.

[Configuration of Device of Present Embodiment]

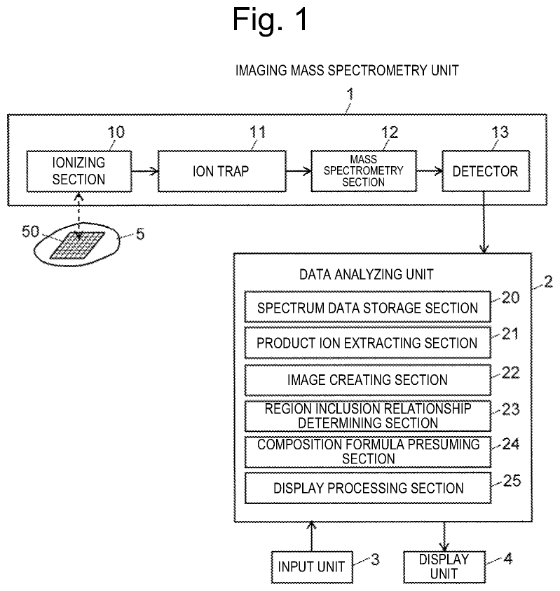

FIG. 1 is a schematic block configuration diagram of an imaging mass spectrometer of the present embodiment.

The imaging mass spectrometer of the present embodiment includes an imaging mass spectrometry unit 1, a data analyzing unit 2, an input unit 3, and a display unit 4.

The imaging mass spectrometry unit 1 executes imaging mass spectrometry on a sample and is capable of performing MSⁿ analysis, where n is greater than or equal to 2. That is, the imaging mass spectrometry unit 1 includes an ionizing section 10, an ion trap 11, a mass spectrometry section 12, and a detector 13.

The ionizing section 10 is, for example, an ion source by an atmospheric pressure matrix-assisted laser desorption/ionization (AP-MALDI) method that irradiates a sample with laser light under an atmospheric pressure atmosphere to ionize a substance in the sample.

The ion trap 11 is, for example, a three-dimensional quadrupole type or linear type ion trap, and temporarily traps ions derived from a sample component, and performs a selection operation of ions having a specific mass-to-charge ratio and a dissociation operation of the selected ion (precursor ion). The ion dissociation operation can be performed by utilizing, for example, collision-induced dissociation (CID).

The mass spectrometry section 12 separates ions discharged from the ion trap 11 with high mass accuracy and mass resolution, and for example, a time-of-flight mass spectrometer or a Fourier transform mass spectrometer such as a Fourier transform ion cyclotron resonance (FT-ICR) type can be used.

In the imaging mass spectrometry unit 1, a position irradiated with laser light for ionization by the ionizing section 10 is scanned within a two-dimensional measurement region 50 on a sample 5 such as a biological tissue section, and mass spectrometry is performed for each of a large number of measurement points (substantially micro regions) in the measurement region 50, whereby mass spectrum data over a predetermined mass-to-charge ratio range can be acquired. In addition, product ion spectrum data over a predetermined mass-to-charge ratio range can be acquired by performing MS² analysis targeting a mass-to-charge ratio designated in advance at a large number of measurement points in the measurement region 50 on the sample 5.

The data analyzing unit 2 receives the mass spectrum data or product ion spectrum data (hereinafter, it may be simply referred to as spectrum data) for each of a large number of measurement points (micro regions) obtained by the imaging mass spectrometry unit 1, and performs analysis processing based on the data. The data analyzing unit 2 includes, as functional blocks, a spectrum data storage section 20, a product ion extracting section 21, an image creating section 22, a region inclusion relationship determining section 23, a composition formula presuming section 24, and a display processing section 25 in order to perform characteristic analysis processing described later.

Although the data analyzing unit 2 can be configured by a hardware circuit, the data analyzing unit 2 is generally a computer such as a personal computer or a high-performance workstation. Each of the functional blocks can be embodied by executing, on the computer, dedicated data analysis software installed in the computer. In this case, the input unit 3 is a keyboard or a pointing device (such as a mouse) attached to the computer, and the display unit 4 is a display monitor.

[Analyzing Operation in Device of Present Embodiment]

In the imaging mass spectrometer of the present embodiment, mass spectrometry imaging data is collected as follows.

The user sets the molecular weight of the target component or the mass-to-charge ratio of the precursor ion derived from the target component as one of the MSⁿ analysis conditions. Of course, normal imaging mass spectrometry (that is, without dissociating ions) may be performed prior to the MSⁿ analysis, and precursor ions to be MSⁿ analyzed may be determined using the result. When the molecular weight of the target component or the mass-to-charge ratio of the precursor ion derived from the component is set as described above, the mass-to-charge ratio range of the precursor ions having a mass tolerance width determined in advance is determined.

The imaging mass spectrometry unit 1 executes normal mass spectrometry on the determined mass-to-charge ratio range of the precursor ions for each of a large number of measurement points set within the measurement region 50 on the sample 5 to acquire signal strength data. Here, scan measurement over a predetermined mass-to-charge ratio range may be executed, and from the result, only the signal strength for the mass-to-charge ratio range of the precursor ions may be extracted. Subsequently, MS/MS analysis by product ion scan measurement on the determined mass-to-charge ratio range of the precursor ions is executed for each of a large number of measurement points set within the measurement region 50 on the sample 5 to acquire product ion spectrum data. All the obtained data are transferred from the imaging mass spectrometry unit 1 to the data analyzing unit 2 and stored in the spectrum data storage section 20.

[Analysis Processing in Device of Present Embodiment]

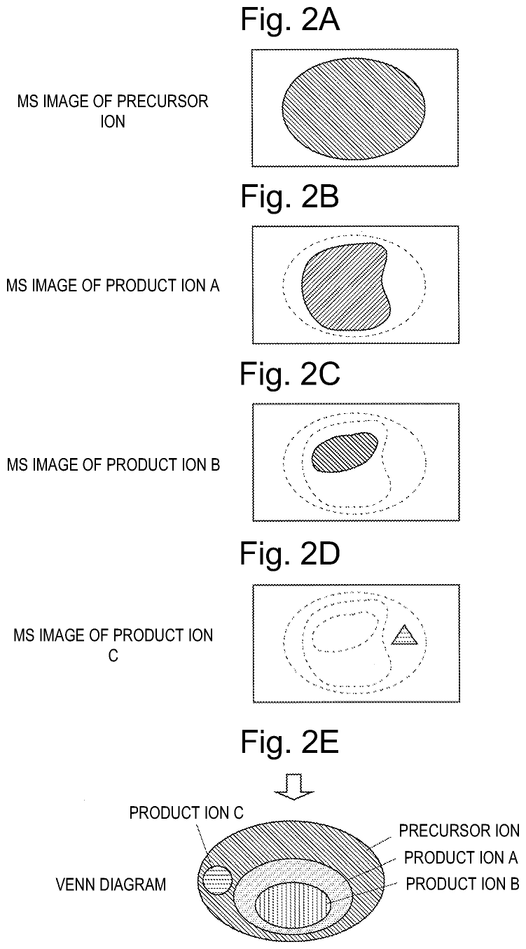

When the user performs a predetermined operation on the input unit 3 in a state where the spectrum data for one sample 5 as described above is stored in the spectrum data storage section 20, the data analyzing unit 2 executes the following analysis processing using the data saved in the spectrum data storage section 20. FIGS. 2A to 2E are explanatory diagrams of this analysis processing.

The product ion extracting section 21 creates an average product ion spectrum obtained by, for example, calculating an average of signal strengths at all measurement points for each mass-to-charge ratio value from the spectrum data at a large number of measurement points obtained for one sample 5. Instead of the average product ion spectrum, for example, a product ion spectrum in which the maximum signal strength is selected among all the measurement points for each mass-to-charge ratio may be used. Then, peak detection is performed in the created product ion spectrum, and product ions are extracted by selecting a plurality of significant peaks.

Specifically, a predetermined number of peaks may be selected in descending order of signal strength among peaks detected from the product ion spectrum, and the product ion corresponding to the relevant peak may be extracted. Of course, there may be no restriction on the number of peaks to be selected. In addition, in a case where unnecessary product ions are known as prior information, the unnecessary product ions may be excluded, and conversely, in a case where there are product ions known to be important even if the signal strength is low, those product ions may be added to the options.

The product ion extracting section 21 may perform various known statistical analysis processing using spectrum data obtained from each of a large number of measurement points within the measurement region 50 on the sample 5, and extract significant product ions based on the result.

For example, Non Patent Literature 1 discloses a technique of segmentation that divides an image into a plurality of regions by detecting discontinuity of pixel values in the image. In addition, Non Patent Literature 2 discloses a technique of classifying an image by color using k-means clustering. When the measurement region 50 is divided into a plurality of small regions by applying such a technology to the spectrum data obtained from each measurement point, there is a high possibility that each small region corresponds to, for example, a site having different characteristics in one biological tissue. Therefore, the product ion extracting section 21 may calculate an average product ion spectrum for each small region, select a predetermined number of peaks in descending order of signal strength from among peaks observed in the average product ion spectrum, and extract the product ion corresponding to the peak. Thus, one or a plurality of product ions can be extracted for each small region expected to be a characteristic site existing in the measurement region 50.

Furthermore, a large number of mass-to-charge ratios m/z can be classified into a plurality of clusters (groups) having similar spatial distributions by applying hierarchical cluster analysis (HCA) to the spectrum data obtained from each measurement point within the measurement region 50. The different mass-to-charge ratios classified into the same cluster have a high possibility of corresponding to ions derived from the same component, or corresponding to ions derived from components that are different from each other but, for example, exhibit similar behavior in vivo. Therefore, a predetermined number of mass-to-charge ratios may be selected in descending order of signal strength from among a plurality of mass-to-charge ratios classified into each cluster, and extracted as product ions. Thus, one or a plurality of product ions can be extracted for each component present in the measurement region 50 or for each component group having similar behavior.

The image creating section 22 reads out data obtained for the precursor ions and the plurality of product ions extracted as described above from the spectrum data storage section 20, and creates MS images for each of the precursor ions and the plurality of product ions. In general, when an MS image is created, a distribution image is created in which the signal strength is associated with a color scale (or gray scale), and the magnitude of the signal strength can be visually recognized with a difference in color. Here, such a distribution image may be created, but for example, a binary image (for example, a black-and-white image) for distinguishing between a measurement point where the signal strength is greater than or equal to a predetermined threshold value (or may be “the signal strength is other than zero”) and other measurement points may be created.

The region inclusion relationship determining section 23 examines the spatial inclusion relationship of the region where each ion exists in the plurality of MS images created by the image creating section 22. Here, since the regions where the precursor ions or the product ions exist are compared among the plurality of MS images, for example, in a case where the MS image is expressed in color scale or gray scale as described above, it is necessary to convert the range of signal strength to the range in which the ions are assumed to exist and perform the comparison. As described above, when the MS image is a binary image, such conversion is unnecessary, and the images can be compared as is. In this respect, it is useful to acquire the MS image as a binary image.

As an example, it is assumed that MS images of precursor ions and MS images of product ions A, B, and C are obtained as shown in FIGS. 2A to 2D (However, the dotted lines illustrated in FIGS. 2B to 2D are not actually displayed.). The region inclusion relationship determining section 23 compares the four MS images to examine the inclusion relationship of the ion existing region in each image. As a result, it is determined that the existing region of the product ion B is included in the existing region of the product ion A, and the existing region of the product ion A is included in the existing region of the precursor ion. On the other hand, it is determined that the existing region of the product ion C is included in the existing region of the precursor ion, but is not included in the existing regions of the product ions A and B.

The display processing section 25 receives the determination result by the region inclusion relationship determining section 23, creates a Venn diagram representing the determination result, and displays the same on the screen of the display unit 4. In the case of the examples illustrated in FIGS. 2A to 2D, a Venn diagram as illustrated in FIG. 2E is created from the inclusion relationship. Even if the MS images as shown in FIGS. 2A to 2D are displayed, it is not easy for the user to understand the spatial relationship of the regions where the plurality of product ions exist. On the other hand, in the case of the Venn diagram as illustrated in FIG. 2E, the user can grasp at a glance the spatial relationship of the regions where the plurality of product ions exist.

In this example, since the product ion A and the product ion B have overlapping existing regions, it can be determined that there is a high possibility that they are product ions derived from the same component. On the other hand, since the product ion C and the product ions A and B do not have overlapping existing regions, it can be determined that there is a possibility that they are product ions derived from different components. In this way, it is possible to identify product ions derived from different components having the same or close mass-to-charge ratio of precursor ions. It becomes easy to select a more appropriate product ion for knowing the two-dimensional distribution of the target component by grasping the spatial inclusion relationship of the regions where such ions exist, and a highly accurate MS image according to the purpose can be obtained.

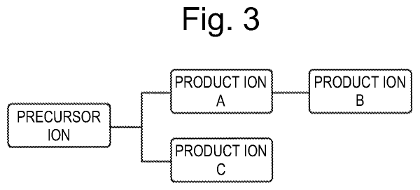

In addition, the display processing section 25 may create a tree diagram as illustrated in FIG. 3 and display the tree diagram on the display unit 4 instead of the Venn diagram as illustrated in FIG. 2E. The inclusion relationship between the precursor ions and the plurality of product ions can also be grasped at a glance by the tree diagram.

In the imaging mass spectrometer of the present embodiment, the composition formula presuming section 24 is provided to add the following functions.

When the mass accuracy of the mass spectrometry section 12 of the imaging mass spectrometry unit 1 is high, specifically, when a Fourier transform mass spectrometer, a multiplex circulation type time-of-flight mass spectrometer, or the like is used, the composition formula of the ion can be presumed with high accuracy from the mass-to-charge ratio value obtained by mass spectrometry (MSⁿ analysis). Therefore, the composition formula presuming section 24 presumes the composition formula from the mass-to-charge ratio for each of the plurality of product ions and precursor ions extracted by the product ion extracting section 21. Then, whether or not the ion having each composition formula can be generated from the molecular formula of the target component specified in advance is determined.

For example, in a case where the number of a certain element in a certain composition formula exceeds the number of the same element in the molecular formula of the target component, it can be determined that the ion having the composition formula is not derived from the target component. In this manner, it is preferable to assume whether or not each product ion is derived from the target component using the composition formula, and display the result as character information in a figure or graph such as a Venn diagram or a tree diagram. For example, when the user operates the input unit 3 to mouse over the notation of the product ion in the Venn diagram or the tree diagram, if the product ion is not an ion derived from the target component, it is preferable to display a tool tip describing such a fact.

Furthermore, instead of using the determination result using the composition formula for display, the product ion assumed not to be derived from the target component may be excluded when the region inclusion relationship determining section 23 examines the inclusion relationship of the regions where the ions exist. This makes it possible to display a Venn diagram or a tree diagram showing only the precursor ions derived from a target component and a plurality of product ions assumed to be derived from the target component.

### Modified Example

In the device of the embodiment described above, a Venn diagram and a tree diagram showing a spatial inclusion relationship between precursor ions and a plurality of product ions are obtained, but neutral losses, which are neutral particles generated when the precursor ions are dissociated thus generating product ions, correspond to the product ions on a one-to-one basis. Therefore, it is obvious that an MS image may be created using a neutral loss having a mass corresponding to the mass-to-charge ratio difference between the precursor ion and the product ion instead of the product ion, or the inclusion relationship of the regions may be examined.

Furthermore, in the device of the embodiment described above, the measurement region on the sample is two-dimensional, but it is a matter of course that the present invention can also be used in a case where the measurement region is three-dimensional.

In the device according to the embodiment described above, product ions obtained as a result of the MS² analysis are used, but product ions obtained as a result of MSⁿ analysis, in which n is greater than or equal to 3, such as MS³ analysis and MS⁴ analysis may be used.

Furthermore, the above-described embodiments and modified examples are merely examples of the present invention, and it is a matter of course that modifications, corrections, additions, and the like appropriately made within the scope of the gist of the present invention are included in the claims of the present application.

[Various Aspects]

The embodiment of the present invention has been described above with reference to the drawings, and lastly, various aspects of the present invention will be described.

An imaging mass spectrometer according to a first aspect of the present invention includes:

an analysis executing section configured to execute MSⁿ analysis (n is an integer greater than or equal to 2) for a target component on each of a plurality of micro regions set in a two-dimensional measurement region on a sample or a three-dimensional measurement region in a sample to collect data;

a product ion extracting section configured to extract a plurality of product ions observed in the sample based on at least a part of the data collected by the analysis executing section;

a two-dimensional distribution image creating section configured to create a two-dimensional distribution image based on data of precursor ions and two-dimensional distribution images based on data of the plurality of product ions at the time of the MSⁿ analysis; and

a distribution relationship visualization section configured to examine a relationship of the two-dimensional distribution images of the precursor ions and the plurality of product ions, creates a figure or a graph indicating an inclusion relationship of the two-dimensional distribution images, and displays the figure or the graph on a display unit.

According to the imaging mass spectrometer of the first aspect, a user can grasp at a glance a relationship of a plurality of product ions observed on a product ion spectrum obtained by the MSⁿ analysis for a target component, for example, whether the product ions are product ions derived from the same component or product ions derived from another component, by looking at the figure or the graph displayed on the display unit. Thus, for example, the user can select an appropriate product ion from a plurality of product ions derived from the target component, create an MS image, and confirm its distribution, or select a product ion of a component other than the target component, create an MS image, and confirm its distribution. As a result, the user can obtain useful information regarding the two-dimensional distribution of the target component contained in the sample and the component other than the target component, that is, new knowledge, which cannot be obtained by the conventional device.

An imaging mass spectrometer according to a second aspect of the present invention is such that, in the first aspect, the distribution relationship visualization section can create a Venn diagram or a tree diagram as a figure or a graph indicating an inclusion relationship of the two-dimensional distribution images of the precursor ions and the plurality of product ions.

According to the imaging mass spectrometer of the second aspect, the user can understand an inclusion relationship of the two-dimensional distribution images of the precursor ions and the plurality of product ions at a glance.

An imaging mass spectrometer according to a third aspect of the present invention can further include, in the first aspect,

a composition formula presuming section configured to presume a composition formula from a mass-to-charge ratio for the plurality of extracted product ions; and

an ion determining section configured to determine whether or not the ion is a product ion derived from the target component based on the presumed composition formula.

An imaging mass spectrometer according to a fourth aspect of the present invention is such that, in the third aspect, the distribution relationship visualization section can add a display based on the determination result by the ion determining section to the figure or the graph.

An imaging mass spectrometer according to a fifth aspect of the present invention is such that, in the third aspect, the distribution relationship visualization section can examine the relationship of the two-dimensional distribution images of the precursor ions and the plurality of product ions, excluding some product ions, based on the determination result by the ion determining section.

According to the imaging mass spectrometer of the fourth aspect, whether or not the product ions indicated in the displayed figure or graph are derived from the target component can be easily and conveniently confirmed on the displayed figure or graph. Thus, for example, work efficiency when selecting an appropriate product ion enhances.

On the other hand, according to the imaging mass spectrometer of the fifth aspect, since a figure or a graph in which only the precursor ion and the product ion derived from a target component are displayed is drawn, unnecessary work of confirming unnecessary information can be omitted when components other than the target component is not a target of interest.

An imaging mass spectrometer according to a sixth aspect of the present invention is such that, in any one of the first to fifth aspects, the product ion extracting section can divide the measurement region into a plurality of small regions or classify mass-to-charge ratio values into a plurality of groups using data obtained by the analysis executing section, and extract a plurality of product ions for each of the small regions or for each of the groups of the mass-to-charge ratio values.

In the imaging mass spectrometer of the sixth aspect, the product ion extracting section may divide the measurement region into a plurality of small regions having the same or similar features using the data obtained by the analysis executing section. Thus, product ions can be extracted for each site having the same or similar features. In the imaging mass spectrometer of the sixth aspect, the product ion extracting section may classify the mass-to-charge ratio values into a plurality of groups having similar spatial distributions using the data obtained by the analysis executing section. The different mass-to-charge ratios having similar spatial distributions have a high possibility of being ions derived from the same component or ions derived from components having similar behavior or dynamics. Therefore, product ions can be extracted for each of the same components or for a component group having similar behavior or dynamics.

An imaging mass spectrometer according to a seventh aspect of the present invention is such that, in the sixth aspect, multi-variable analysis can be used when dividing the measurement region into a plurality of small regions or classifying the mass-to-charge ratio values into a plurality of groups.

The multi-variable analysis here can include a non-hierarchical cluster analysis method such as k-means and various statistical analysis methods such as HCA. Furthermore, an image analysis method such as edge detection and texture analysis may be used. In addition, a machine learning method such as deep learning may be used. According to the imaging mass spectrometer of the seventh aspect, the measurement region can be accurately divided into a plurality of small regions or a large number of mass-to-charge ratio values can be accurately classified into a plurality of groups, and a significant product ion can be extracted for each of the small regions or each of the groups.

### REFERENCE SIGNS LIST

1 . . . Imaging Mass Spectrometry Unit
10 . . . Ionizing Section
11 . . . Ion Trap
12 . . . Mass Spectrometry Section
13 . . . Detector
2 . . . Data Analyzing Unit
20 . . . Spectrum Data Storage Section
21 . . . Product Ion Extracting Section
22 . . . Image Creating Section
23 . . . Region Inclusion Relationship Determining Section
24 . . . Composition Formula Presuming Section
25 . . . Display Processing Section
3 . . . Input Unit
4 . . . Display Unit
5 . . . Sample
50 . . . Measurement Region

1. An imaging mass spectrometer comprising:
an analysis executing section configured to execute MSⁿ analysis (n is an integer greater than or equal to 2) for a target component on each of a plurality of micro regions set in a two-dimensional measurement region on a sample or a three-dimensional measurement region in a sample to collect data;
a product ion extracting section configured to extract a plurality of product ions observed in the sample based on at least a part of the data collected by the analysis executing section;
a two-dimensional distribution image creating section configured to create a two-dimensional distribution image based on data of precursor ions and two-dimensional distribution images based on data of the plurality of product ions at the time of the MSⁿ analysis; and
a distribution relationship visualization section configured to examine a relationship of the two-dimensional distribution images of the precursor ions and the plurality of product ions, create a figure or a graph indicating an inclusion relationship of the two-dimensional distribution images, and display the figure or the graph on a display unit.

2. The imaging mass spectrometer according to claim 1, wherein the distribution relationship visualization section creates a Venn diagram or a tree diagram as a figure or a graph indicating an inclusion relationship of the two-dimensional distribution images of the precursor ions and the plurality of product ions.

3. The imaging mass spectrometer according to claim 1, further comprising:
a composition formula presuming section configured to presume a composition formula from a mass-to-charge ratio for the plurality of extracted product ions; and
an ion determining section configured to determine whether or not the ion is a product ion derived from the target component based on the presumed composition formula.

4. The imaging mass spectrometer according to claim 3, wherein the distribution relationship visualization section adds a display based on the determination result by the ion determining section to the figure or the graph.

5. The imaging mass spectrometer according to claim 3, wherein the distribution relationship visualization section examines the relationship of the two-dimensional distribution images of the precursor ions and the plurality of product ions, excluding some product ions, based on the determination result by the ion determining section.

6. The imaging mass spectrometer according to claim 1, wherein the product ion extracting section divides the measurement region into a plurality of small regions or classify mass-to-charge ratio values into a plurality of groups using data obtained by the analysis executing section, and extracts a plurality of product ions for each of the small regions or for each of the groups of the mass-to-charge ratio values.

7. The imaging mass spectrometer according to claim 6, wherein multi-variable analysis is used when dividing the measurement region into a plurality of small regions or classifying the mass-to-charge ratio values into a plurality of groups.
